(19) United States
(12) Patent Application Publication
(10) Pub. No.: US 2010/0225584 A1
(43) Pub. Date: Sep. 9, 2010

(54) SILENT OR LOUD 3D INFRARED FUTURISTIC COMPUTER MICE AND KEYBOARD DESIGN FOR A MICE&KEYBOARD LESS COMPUTER

(76) Inventor: John Cauchi, Sunnyvale, CA (US)

Correspondence Address: John Cauchi, 1634 Canary Drive, Sunnyvale, CA, 94087, US

(21) Appl. No.: 12/799,457

(22) Filed: Jun. 8, 2008

(51) Int. Cl. G06F 3/033

(52) U.S. Cl. 345/158

(57) ABSTRACT

New futuristic silent or loud 3D computer mice and key board design for a mice and keyboard less computer is presented. The current invention uses the fact that each word spoken by humans has a distinctive three dimensional pattern of the mouth and face and unique infrared spectrum. Using this fact, the present invention presents a method where the facial expression, irradiated by an array of infrared diodes, of the spoken word is picked up by infrared sensors installed either in stand alone mode, on top of the computer display or directly into the computer display to translate any spoken word silent or loud into computer commands that will facilitate the interaction of humans and computers without the use of a keyboard or mouse.

### BACKGROUND OF THE INVENTION

The present invention relates to computer mice and keyboards. Computer mice 100 (FIG. 1) are used to interact with the computer to drive specific instruction such as opening programs, files, folders, interact with websites in the internet (Copy and paste information from a website) and navigate on opened programs such as word (word processing) and excel (data processing).

Computer keyboards 110 (FIG. 1) are used to type in data into both the word and data processing programs, which are displayed on a computer monitor 120 (FIG. 1) and for a variety of other data entry functions.

So basically both computer mice and keyboards are the only gateways for humans to interact with the computers. The biggest trade off of the keyboard and mice is that humans have to use their hands all the time to interact with the computer. The heavy usage of the hands leads eventually to fatigue of the hand ligaments or wrist leading humans to develop what is known as carpal tunnel syndrome, a medical condition in which the median nerve is compressed at the wrist.

The present invention intends to develop a new method for interacting with the computer that doesn't involve the heavy usage of the human hands.

The new method is called silent or loud 3D futuristic computer mice and keyboard design for a keyboard and mice less computer.

### SUMMARY

The invention is defined by the appended claims which are incorporated into this section in their entirety. The rest of this section summarizes some features of the invention. Some embodiments of the current invention provide alternative methods for humans to interact with the computer. The current invention uses the fact that each word spoken by humans has a distinctive three dimensional (3D) pattern of the mouth and face 130 (FIG. 2) and unique infrared spectrum when irradiated with an infrared or lower power diode array 140 (FIG. 3). Using this fact, the present invention presents a method where the facial expression, irradiated by an array of infrared or low power diodes 140 (FIG. 3), of the spoken word is picked up by highly sensitive infrared sensors 150 (FIG. 3) installed either in stand alone mode, on top of the computer display 160 (FIG. 3) or directly into the computer display. The infrared sensors along with a graphics card, microprocessor and software translates any spoken word silent or loud into computer commands by creating a 3D image of the spoken word and matching to a pre-loaded 3D images or by matching the unique infrared spectrums of the spoken word to pre-loaded spectrums of the spoken word. This new method will facilitate the interaction of humans and computers without the use of a keyboard or mouse.

### BRIEF DESCRIPTION OF THE FIGURES

FIG. 1 Prior art of a standard computer with monitor, mouse and keyboard.

FIG. 2 Prior art of a side ways spoken word facial expression for the word NO showing the protruding lips.

FIG. 3 Drawing showing a computer with the present invention without a keyboard or mouse and showing infrared sensor array and infrared or low power diode array.

FIG. 4 Prior art showing infrared spectrum, different temperatures, of a still human face and infrared spectrum when the face is irradiated, close to the mouth and at the far end of the cheeks, by an infrared or low power diode. It also shows temperature bar from 75 F. (Degrees Fahrenheit) to 105 F. to judge the temperature.

FIG. 5 Prior art showing a diode's beam spread and spot size.

FIG. 6 Flow chart showing how the present invention works from the time the command is spoken until the computer reacts to it.

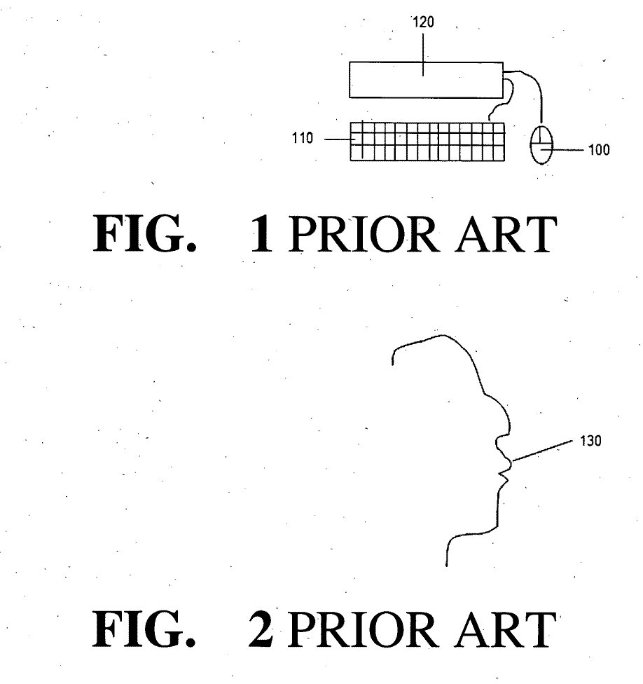

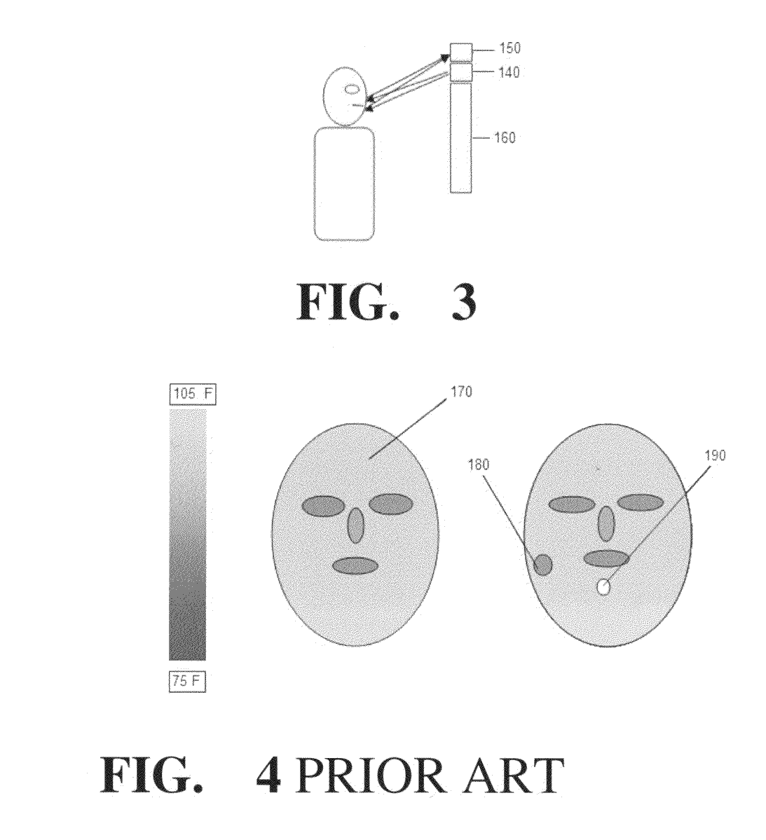

### DESCRIPTION OF THE INVENTION

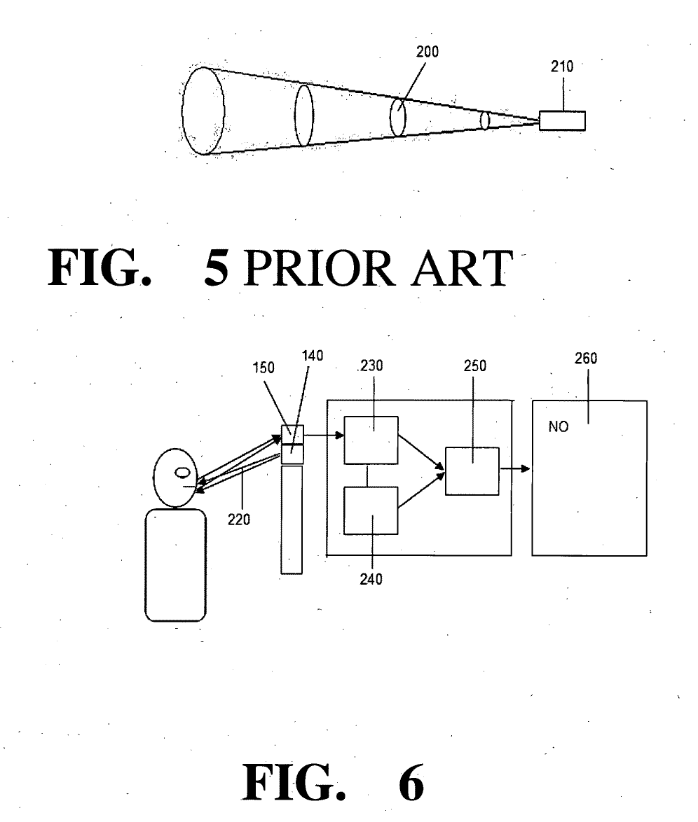

The invention will make use of highly sensitive infrared sensors 150 (FIG. 6) which will detect the natural infrared radiation of the face. Additionally, an array of infrared or low power diodes 140 (FIG. 6) will send beams of light 180 (FIG. 6) towards the lower part of the face. Once the infrared lights hit the human face, the natural infrared spectrum of the face 170 (FIG. 4) will change according to where the infrared lights hit the face. For instance, the farthest part of the left cheek 180 (FIG. 4) will look different than closer to the lips 190 (FIG. 4) since they are at different distances from the infrared diodes array. Also, using the fact that a diode light beam 200 (FIG. 5) will spread wider the longer in travels, the light beam hitting the lips is narrower than the beam hitting the farthest part of the left cheek. The narrower beam has more concentration of energy than the wider beam. Thus, the narrower beam will heat up a surface faster than the wider beam. So, on the infrared sensor array 150 (FIG. 6), on a still face, the area-around the lips 190 (FIG. 4) hit by the narrower beam will appear hotter than the area hit by the wider beam on the farther part of the check 180 (FIG. 4). As the lower part of the face moves to speak a word like NO, for instance, the different parts of the lower part of the face that move to pronounce the word NO will either be closer or farther to the array of infrared diodes 140 (FIG. 6). Those different parts will become hotter or colder as they move to say the word NO. The infrared sensors 150 (FIG. 6) then will pick up these hot/cold infrared spectrums and send the data to the computer's microprocessor 240 (FIG. 6), 3D Graphics card 230 (FIG. 6) and Software 250 (FIG. 6) that will translate the signals into a 3D image of the face movement for the word NO or the different infrared spectrums generated for the word NO could be stored in memory.

The microprocessor, 3D graphics and Software will use the physical properties of a pre-calibrated infrared LED 200 (FIG. 5) to created the 3-D image of each movement of the lower face as it pronounces the word NO. Since the circumference or spot size 200 (FIG. 5) of the infrared diodes 210 (FIG. 5) beam grows bigger the longer it travels, distance from the infrared diodes to the face can be calculated by using the spot size detected by the infrared sensors. The infrared sensors will detect all the spot sizes generated by the array of infrared diodes shining on the face and send this data to the microprocessor/3D Graphics card/Software to created a 3-D image for the complete face movement when saying the word NO and compares the 3-D image with pre-loaded 3D human images or infrared spectrum images. If there is match, the microprocessor/3D Graphics card/Software sends a command to the computer to type the word NO.

With this new invention, commands that used to be sent through the computer's keyboard and mouse will be sent through spoken, loud or silent, words. Thus, this new invention leads to a future computer without a keyboard or mouse.

1. Silent or loud 3D infrared futuristic computer mice and keyboard design for a mice and keyboard less computer.

2. Mice and keyboard less computer where commands are given by infrared facial expressions picked up by infrared sensors integrated either on display or standalone.

3. Any device being electronic or not that uses facial expressions irradiated by low power diodes which signal is detected by infrared sensors to give commands.
